(19) United States
(12) Patent Application Publication
(10) Pub. No.: US 2016/0229004 A1
(43) Pub. Date: Aug. 11, 2016

(54) WELDING JIG FOR PEDICLE SCREW, WELDING APPARATUS FOR PEDICLE SCREW AND WELDING METHOD FOR PEDICLE SCREW USING THE SAME

(71) Applicants: SOO JUNG MOON, Addison, TX (US); IL SEOP SEO, Gimhae (KR)

(72) Inventors: SOO JUNG MOON, Addison, TX (US); IL SEOP SEO, Gimhae (KR)

(21) Appl. No.: 14/699,271

(22) Filed: Apr. 29, 2015

(30) Foreign Application Priority Data
Feb. 11, 2015 (KR) 10-2015-0020781

(51) Int. Cl. B23K 37/04; B23K 31/02

(52) U.S. Cl. CPC B23K 37/0426; B23K 31/02

(57) ABSTRACT

A welding jig for pedicle screw has a jig core, a head holder, and a pair of wing holders. The jig core includes a first mounting part inserted into a screw head of a pedicle screw, and a second mounting part to which a pair of wings to be welded to the screw head are attached to an outer surface thereof. The head holder covers the screw head and locks the screw head to the first mounting part, and the pair of wing holders covers the pair of wings and locks the pair of wings to the second mounting part by being coupled to each other. A welding apparatus for pedicle screw includes the welding jig for pedicle screw, a turntable, and a welding torch. The turntable has the jig locked thereto, and the welding torch applies power to the welding regions of the wings and the screw head.

### CROSS-REFERENCE TO RELATED APPLICATIONS

This Application claims the benefit of priority to Korean Patent Application No. 10-2015-0020781 filed on Feb. 11, 2015, which is incorporated by reference in its entirety.

### FIELD OF THE INVENTION

The present disclosure relates to a welding jig for pedicle screw, a welding apparatus for pedicle screw, and a welding method for pedicle screw using the same, which allow precise and stable welding of the screw head and the wing of a pedicle screw.

### BACKGROUND OF THE INVENTION

Spondylopathy generally refers to a disorder in which pain is induced by pressure exerted on the nerves adjacent to the vertebral column as a result of narrowed space between the vertebrae due to degeneration of the bones, ligaments, muscles, etc. or as a result of spinal deformity caused by poor posture.

Therefore, in patients with a partially damaged or injured spine, an artificial aid is used to fasten the adjacent spinal sections such that the injured section is not pressed against, and pedicle screws are widely used for fastening the spine.

There have been recent developments in pedicle screws used for minimal invasive surgery (MIS) in order to expedite recovery and minimize post-surgical scars. An MIS pedicle screw consists of a screw head and a wing (wing section) formed longitudinally to the screw head. While the screw can be integrally manufactured through machining, machining has problems of high defect rate and material loss. Thus, commonly used methods nowadays involve separately manufacturing the screw head and the wing and, thereafter, welding the wing to the screw head using a laser.

However, laser welding has a limitation in that only the laser-irradiated regions are melted and welded but not the inside of the laser-irradiated regions. Moreover, due to an under-cut effect, in which welding regions melt and are lowered, it also has a disadvantage in appearance.

### SUMMARY

To solve the above problems, the present disclosure provides a welding jig for pedicle screw comprising: a jig core comprising a first mounting part inserted into a screw head of a pedicle screw, and a second mounting part to which a pair of wings to be welded to the screw head are attached to an outer surface thereof; a head holder covering the screw head and locking the screw head to the first mounting part; and a pair of wing holders covering the pair of wings and locking the pair of wings to the second mounting part by being coupled to each other.

According to an embodiment, the head holder has a pair of blocks installed on opposing sides thereof, the pair of blocks pressing opposing sides of the outer surface of the screw head enclosed in the head holder inward to restrict rotation of the screw head.

According to an embodiment, each of the opposing sides of the outer surface of the screw head has a groove into which a respective one of the pair of blocks is inserted.

In an embodiment, the welding jig may also include a lock nut; wherein the first mounting part comprises a screw section at one end thereof, and the lock nut is fastened to the screw section, the lock nut firmly locking the head holder and the screw head to the first mounting part by pushing against the head holder.

In an embodiment, the interior of the jig core may have a flow passage formed longitudinally, the flow passage having an inert gas fed thereto, and the outer surface of the jig core has a purge hole which is connected to the flow passage and which sprays the inert gas onto the inside of the welding regions of the screw head and the wings.

In an embodiment, each of the pair of wings may have a first bridge extended from a region of contact with the screw head, the screw head has a second bridge coupled to the first bridge, and the first and second bridges are removed after completion of welding.

Moreover, an embodiment of the present disclosure provides a welding apparatus for pedicle screw comprising: a welding jig for pedicle screw comprising a jig core, a head holder, and a pair of wing holders; a turntable having the jig locked thereto; and a welding torch for applying power to welding regions of the pair of wings and the screw head locked to the jig core.

In an embodiment, the turntable may have a rotational speed in the range of 0.1-10 rpm. The electric current applied to the welding regions by the welding torch is preferably less than or equal to 100 A and the voltage preferably less than or equal to 20 V.

Furthermore, an embodiment of the present disclosure provides a welding method for pedicle screw comprising: locking a screw head of a pedicle screw to a first mounting part of a jig core; locking a pair of wings to a second mounting part of the jig core in such a manner that a welding region of the pair of wings comes in contact with a welding region of the screw head; locking the jig core to the top surface of a turntable; a rotating the turntable; and applying power to the welding regions of the screw head and the wings by using a welding torch.

In an embodiment, the step for locking the screw head to the first mounting part comprises: inserting the first mounting part into the screw head; covering the screw head using a head holder; and pressing the head holder by coupling a lock nut to a screw section formed at the end of the first mounting part.

In an embodiment, locking the pair of wings to the second mounting part comprises: attaching the pair of wings to an outer surface of the second mounting part; and covering the pair of wings with a pair of wing holders and thereafter coupling the wing holders to each other.

In an embodiment, the welding method further comprises preheating the welding regions of the screw head and the wings before the turntable starts to rotate. In an embodiment, the welding method may include spraying an inert gas onto the inside of the welding regions of the screw head and the wings during welding of the screw head and the wings.

Embodiments of the present disclosure are capable of preventing deformation of the welding regions of the screw head and the wing that is caused by high-temperature heat applied during welding, as the welding of the screw head and the wing is carried out after firmly locking them to a jig.

Moreover, unlike the conventional laser welding, the contact regions of the screw head and the wing in the present disclosure are melted and welded as a whole, thus allowing collective welding of the inside, as well as the surface.

Furthermore, because the contact regions of the screw head and the wing are melted and welded as a whole, embodiments of the present disclosure do not suffer from an under-cut effect that arises from the conventional laser welding, but rather benefit from a superior effect in terms of aesthetics and strength due to the bulbous bead formed along the welding regions.

### BRIEF DESCRIPTION OF THE DRAWINGS

FIG. 1 is a perspective view illustrating the overall structure of a welding jig for pedicle screw according to an embodiment of the present disclosure.

FIG. 2 is an exploded perspective view of a welding jig for pedicle screw according to an embodiment of the present disclosure.

FIG. 3 is a sectional view illustrating the state in which a screw head is locked to a first mounting part by means of a head holder, according to an embodiment of the present disclosure.

FIG. 4 illustrates the state in which an inert gas is sprayed onto the inside of welding regions through a purge hole, according to an embodiment of the present disclosure.

FIG. 5 is a perspective view illustrating a pedicle screw in the state of having a first and a second bridge removed therefrom, according to an embodiment of the present disclosure.

FIG. 6 is a schematic drawing of a turntable and the structure of a welding torch, according to an embodiment of the present disclosure.

### DETAILED DESCRIPTION

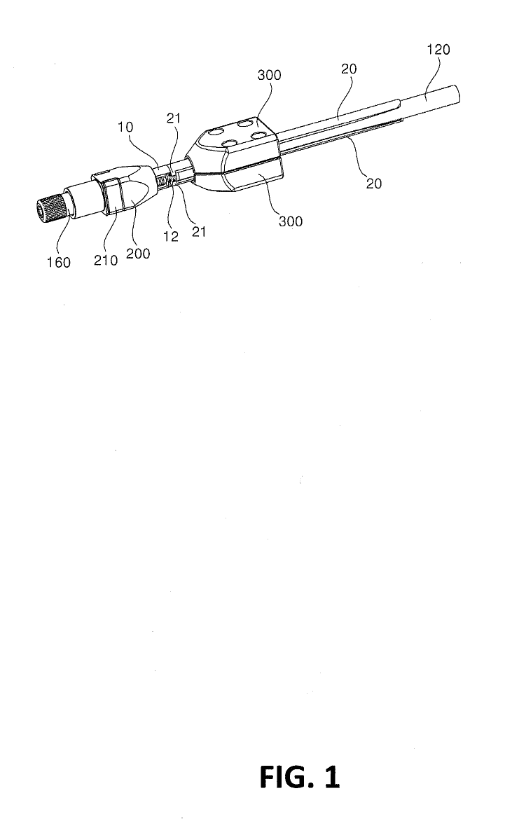

Hereinafter, embodiments of the present disclosure are described in detail with reference to FIGS. 1-6. Regarding the reference numerals assigned to the elements of each figure, it should be noted that identical elements were assigned the same numerals whenever possible, even when appearing in different figures. In addition, detailed descriptions of known features or functions related to the present disclosure were omitted if it was determined that they might obscure the essentials of the present disclosure.

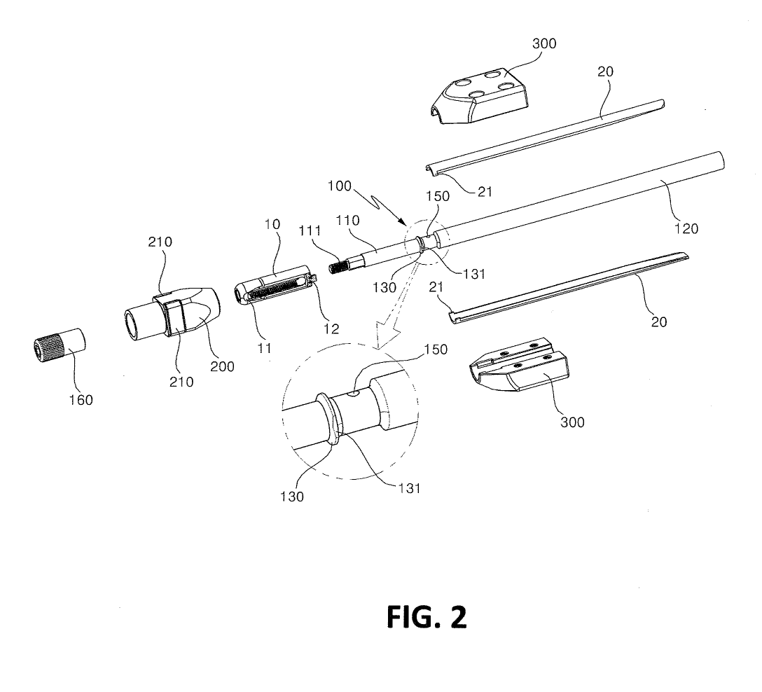

FIG. 1 is a perspective view illustrating the overall structure of a welding jig for pedicle screw according to an embodiment of the present disclosure. FIG. 2 is an exploded perspective view of a welding jig for pedicle screw according to an embodiment of the present disclosure.

As illustrated in FIG. 1 and FIG. 2, a welding jig for pedicle screw according to the present disclosure comprises a jig core (100), a head holder (200), and a wing holder (300).

The jig core (100) consists of a first mounting part (110) which is inserted into a screw head (10) of a pedicle screw, and a second mounting part (120) to which a pair of wings (20) to be welded to the screw head (10) is attached to the outer surface thereof.

Here, the first mounting part (110) and the second mounting part (120) are divided by a partition wall (130). Therefore, the screw head (10) and the pair of wings (20) are positioned in such a manner that the welding regions come in contact with each other, with the partition wall (130) in between.

The head holder (200) covers the screw head (10) and axially locks the screw head (10) to the first mounting part (110). In an embodiment, the head holder (200), screw head (10), and the first mounting part (110) are concentric.

In an embodiment, the head holder (200) presses on the outer surface of the screw head (10), and thereby substantially restricts the screw head (10) from rotating inside the head holder (200). For this purpose, a pair of blocks (210) is installed on both sides of the head holder (200).

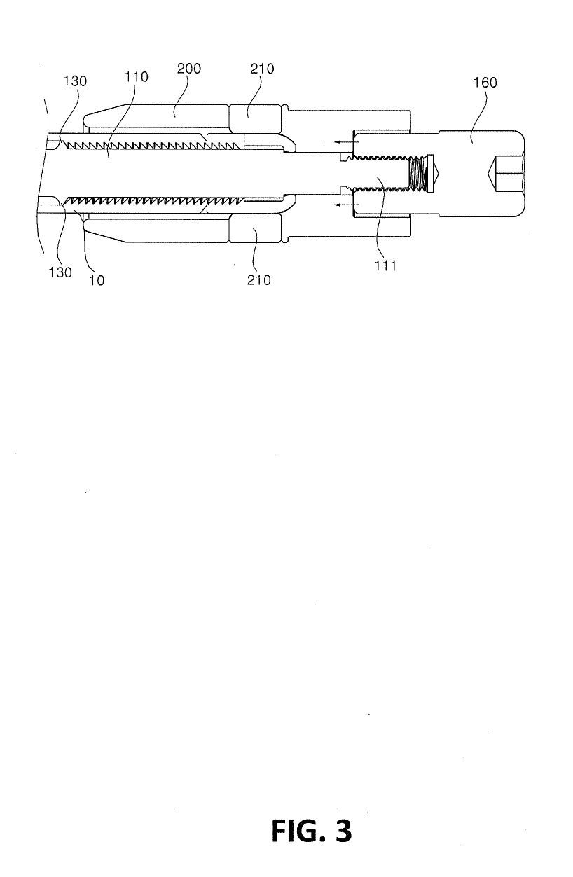

FIG. 3 is a cross-sectional view illustrating the state in which a screw head is locked to a first mounting part by means of a head holder, according to the present disclosure.

The block (210) is fixed to opposing sides of the screw head (10) by welding in such a manner that the inner surface of the block (210) projects towards the inside of the head holder (200), as illustrated in FIG. 3. Therefore, when the screw head (10) is inserted inside the head holder (200), two opposing sides of the screw head (10) are pressed against by the pair of blocks (210), and thus rotation is substantially restricted.

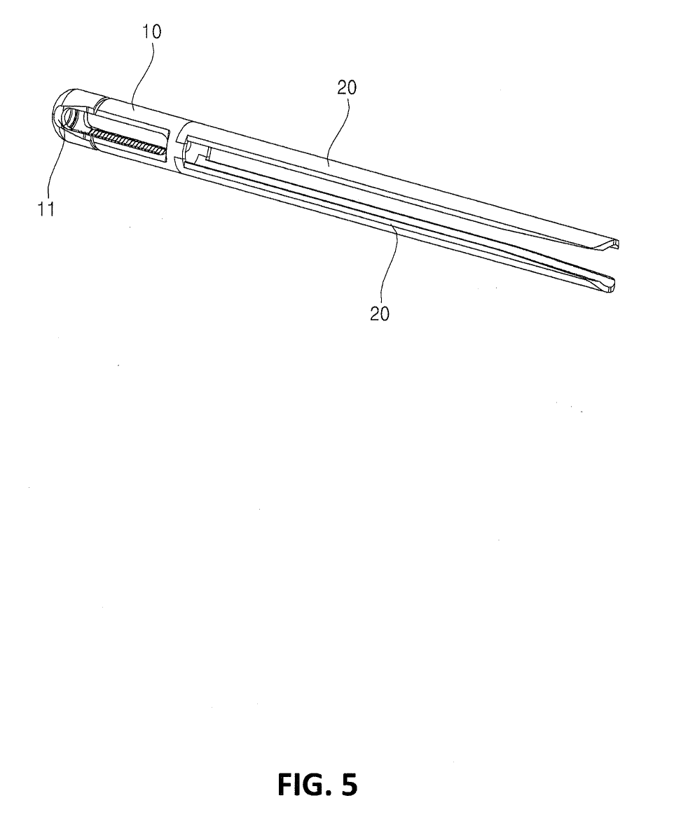

According to an embodiment, a groove (11), which engages with the block (210), may be formed on one or two opposing each of both sides of the outer surface of the screw head (10) (see FIG. 2 and FIG. 5). According to the illustrated embodiment, the block (210) is positioned by inserting the projecting inner surface of the block (210) into each groove (11) of the screw head (10) when the screw head (10) is pushed inside the head holder (200), and thus rotation of the screw head (10) can be substantially restricted with greater stability.

The first mounting part (110) of the jig core (100) has a screw section (111) at the end thereof, and the screw section (111) has a lock nut (160) fastened thereto.

The lock nut (160), as illustrated in FIG. 3, is inserted inside the head holder (200) and fastened to the screw section (111), thereby pushing against the head holder (200) towards the second mounting part (120) (FIG. 3, arrow). In the illustrated embodiment, the partition wall (130) blocks the head holder (200) and restricts its movement, and therefore, the head holder (200) is firmly locked to the first mounting part (110) by means of the lock nut (160). Consequently, the screw head (10) locked inside the head holder (200) is also firmly locked to the first mounting part (110).

A pair of the wing holders (300) is installed onto the second mounting part (120) so as to cover each of the pair of wings (20), and locks the pair of wings (20) to the second mounting part (120) by being coupled to each other.

The pair of wings (20) is attached to the outer surface of the second mounting part (120), and thus may easily break away from the corresponding positions by external force. Therefore, for a stable execution of welding, it is necessary to position a second bridge (12) of the head and a first bridge (21) of the wing or the corners of the wing (20) to fit the respective corners, and to firmly lock the pair of wings (20) to the second mounting part (120) using the wing holders (300).

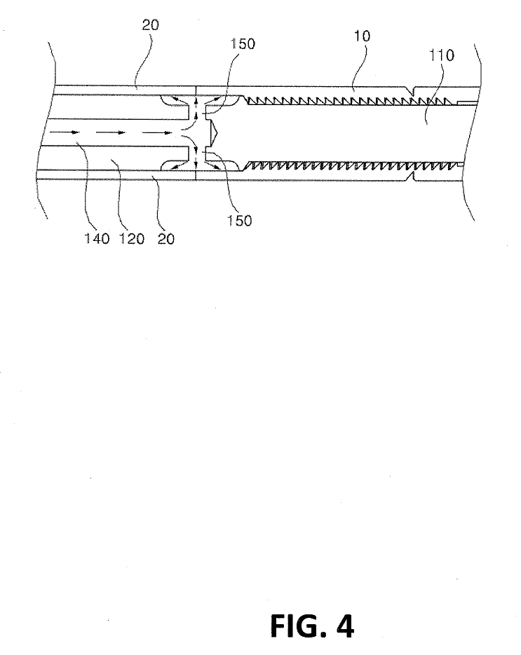

FIG. 4 illustrates the state in which an inert gas is sprayed onto the inside of welding regions through a purge hole, according to an embodiment of the present disclosure.

The interior of the jig core (100) has a flow passage (140) formed longitudinally, the flow passage (140) having an inert gas fed thereto. The outer surface of the jig core (100) has a purge hole (150) which is connected to the flow passage (140) and which sprays the inert gas onto the inside of the welding regions of the screw head (10) and the wings (20).

When a welding region comes into contact with oxygen during welding, it undergoes an oxidation process, which results in a reduced welding strength with a side effect of having a change in the physical properties of the material. Therefore, during welding, an inert gas is continuously sprayed onto the inside of the welding regions through the purge hole (150), thereby removing oxygen.

Although not illustrated, the inert gas is also continuously sprayed onto the outside of the welding regions of the screw head (10) and the wings (20), using a gas nozzle, etc., during welding, so that oxidation is substantially to entirely prevented.

Each of the pair of wings (20) has a first bridge (21) extended at a region of contact with the screw head (10), and the screw head (10) has a second bridge (12) coupled to the first bridge (21) (see FIG. 1 and FIG. 2).

The first and second bridges (21, 12) serve the function of locking the screw head (10) and the wings (20) to the assigned positions, by being engaged to each other when the screw head (10) and the wings (20) are positioned to the first and second mounting parts (110, 120), respectively.

To describe the above in greater detail, the welding region of the screw head (10) and the welding region of the wing (20) will naturally meet each other when the second bridge (12) of the wing (20), which is attached to the second mounting part (120), is coupled to the first bridge (21) while the screw head (10) is inserted into the first mounting part (110). At this stage, if the screw head (10) and the wing (20) are respectively locked to the first and second mounting parts (110, 120) using the aforementioned head holder (200) and wing holder (300), then the screw head (10) and the wing (20) will naturally be locked to the assigned positions.

According to an embodiment, a separate groove (131), into which the second bridge (12) is inserted, may be formed on the partition wall (130) dividing the first and second mounting parts (110,120) (see FIG. 2). In this case, the locking position of the screw head (10) is naturally determined when the second bridge (12) is inserted into the groove (131) formed on the partition wall (130), and consequently, the position of the wing (20) is also determined. Thus, locking of the screw head (10) and the wing (20) can be executed with greater precision and efficiency.

In addition, when the first and second bridges (21, 12) are engaged, the deformation of the welding regions of the screw head (10) and the wing (20) caused by high-temperature heat applied during welding can be prevented to the greatest extent possible.

FIG. 5 is a perspective view illustrating a pedicle screw, according to the present disclosure, in the state of having a first and a second bridge removed therefrom.

Following the completion of welding, these first and second bridges (21, 12) are removed from the screw head (10) and the wing (20) through machining, etc., as illustrated in FIG. 5. Therefore, it is preferred that, during welding, the start region and the end region of welding, in which the base metal swells or sinks, are positioned on the top of the first and second bridges (21, 12) such that these regions are removed along with the first and second bridges (21, 12) after welding is completed.

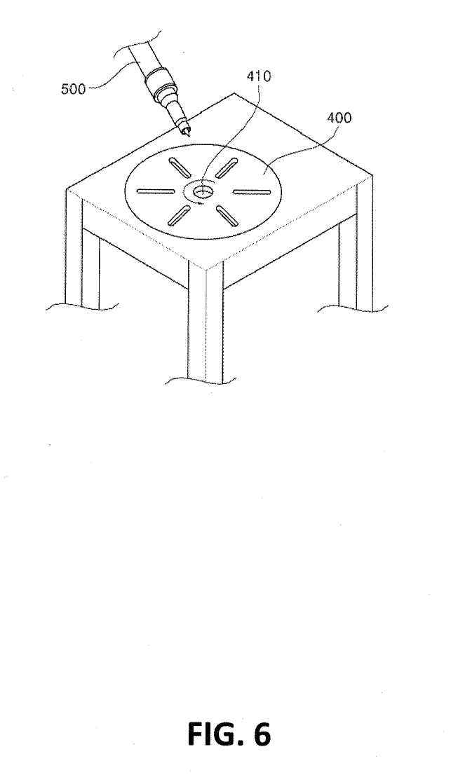

FIG. 6 is a schematic drawing of a turntable and the structure of a welding torch, according to the present disclosure.

A welding apparatus for pedicle screw according to the present disclosure comprises the aforementioned welding jig for pedicle screw, and a turntable (400) and a welding torch (500) as illustrated in FIG. 6.

The turntable (400) is rotated at a constant speed when the welding jig for pedicle screw is locked to the top surface thereof during welding. For this purpose, a locking hole (410), into which the jig is inserted, is formed on the top surface of the turntable (400), and a driving gear (not illustrated), such as a motor, is installed on the lower side of the turntable (400). The structure of the turntable (400) is certainly not limited to the above, and a wide range of modifications are possible and within the scope of the present disclosure.

According to an embodiment, the rotational speed of the turntable (400) may be set to be in the range of 0.1-10 rpm.

The welding torch (500) applies power to the welding regions of the screw head (10) and the wing (20), which are locked to the jig core (100) of the first and second mounting parts (110, 120), such that these welding regions are melted and welded.

More specifically, when welding begins and power is applied from the outside, the welding torch (500) touches the welding regions of the screw head (10) and the wing (20), enabling the external power to be applied to these regions, such that the contact regions of the screw head (10) and the wing (20) are melted by heat and welded.

According to an embodiment, the electric current applied to the welding torch (500) may be less than or equal to 100 and the voltage may be less than or equal to 20 V, in view of the materials, etc. of the screw head (10) and the wing (20).

Such a welding technique is suitable for welding a pedicle screw, which is a medical instrument allowing no material aside from the base metal, as it does not employ melting and welding of a welding rod. Moreover, unlike laser welding, in which only the laser-irradiated exterior is melted and welded, this technique allows the welding regions of contact to be melted and welded as a whole, and therefore, the inside of the welding regions is also simultaneously welded.

In addition, because the contact regions of the screw head (10) and the wing (20) in embodiments of the present disclosure are melted and welded as a whole, the embodiments of the present disclosure do not have an under-cut effect that arises from the conventional laser welding, but rather has a superior effect in terms of aesthetics and strength due to the bulbous bead formed along the welding regions.

Provided below is a brief description of a process for welding a screw head (10) and a wing (20), using a welding jig and a welding apparatus for pedicle screw, constructed as above, according to an embodiment of the present disclosure.

First, place a screw head (10) onto a first mounting part (110) of a jig core (100). If a second bridge (12) is formed on the screw head (10), then insert the second bridge (12) into a groove (131) formed on a partition wall (130) such that the screw head (10) is locked to the assigned position.

Next, place a head holder (200) over the screw head (10), and thereafter push the head holder (200) by coupling a lock nut (160) to a screw section (111) of the first mounting part (110), thereby firmly locking the screw head (10), together with the head holder (200), to the first mounting part (110).

Next, attach a pair of wings (20) to a second mounting part (120) such that a welding region of the wing (20) comes in contact with a welding region of the screw head (10).

Here, if a first bridge (21) is formed on the wing (20), then coupling the first bridge (21) to the second bridge (12) will allow the wing (20) to be positioned on the second mounting part (120) while having the welding region thereof coming in solid contact with that of the screw head (10).

Next, have a pair of wing holders (300) cover the pair of wings (20) attached to the second mounting part (120), and thereafter have the wing holders (300) coupled to each other, thereby locking the wings (20) to the second mounting part (120). In an embodiment, each of the pair of wing holders (300) covers a respective one of the pair of wings (20).

Next, lock the jig, to which the screw head (10) and the wings (20) are locked, to the top surface of a turntable (400), and thereafter apply power to the welding regions of the screw head (10) and the wings (20) by using a welding torch (500), so that these regions are melted and welded. In an embodiment, the welding jig for pedicle screw is locked to the top surface of the turntable (400) by inserting one end of the jig into a locking hole (410) of the turntable (400).

The power is applied to the welding regions of the screw head (10) and the wings (20) while the turntable (400) is being rotated. Consequently, welding of the screw head (10) and the wings (20) is achieved as the welding regions of contact are melted as a whole.

According to an embodiment, prior to the aforementioned welding operation, i.e., before the turntable (400) starts to rotate, the welding regions of the screw head (10) and the wings (20) are preheated for approximately 1-5 sec. The aforementioned welding operation can be carried out more rapidly and smoothly if melting of the welding regions takes place above a certain extent by preheating.

During the aforementioned welding operation, an inert gas may be continuously fed through a flow passage (140) formed inside the second mounting part (120). The inert gas is sprayed onto the inside of the welding regions of the screw head (10) and the wings (20) through a purge hole (150), such that oxidation is hindered on the inside of these welding regions.

According to an embodiment, a separate gas supply pipe is connected to the welding torch (500), etc. such that, during welding, the inert gas is also continuously sprayed onto the outside of the welding regions of the screw head (10) and the wings (20).

After welding of regions of the screw head (10) and the wings (20) is completed, the screw head (10) and the wing (20) are detached from the jig, and thereafter, the first and second bridges (21, 12) are removed through machining, etc., thereby obtaining a pedicle screw as illustrated in FIG. 5.

The above description was provided only to exemplify the technical concept of the present disclosure. Hence, a person skilled in the art would be able to make various changes and modifications without deviating from the essence and spirit of the present disclosure.

Therefore, the embodiments disclosed in the present specification are meant to describe, but not limit, the technical concept of the present disclosure. Thus, the scope of the technical concept of the present disclosure is not limited to these embodiments.

### REFERENCE NUMERALS

10: Screw head
20: Wing
100: Jig core
110: First mounting part
120: Second mounting part
130: Partition wall
11,131: Groove
140: Flow passage
150: Purge hole
160: Lock nut
200: Head holder
210: Block
300: Wing holder
400: Turntable
410: Locking hole
500: Welding torch

What is claimed is:

1. A welding jig for pedicle screw comprising:
a jig core comprising a first mounting part inserted into a screw head of a pedicle screw, and a second mounting part to which a pair of wings to be welded to the screw head are attached to an outer surface thereof;
a head holder covering the screw head and locking the screw head to the first mounting part; and
a pair of wing holders covering the pair of wings and locking the pair of wings to the second mounting part by being coupled to each other.

2. The welding jig for pedicle screw according to claim 1, wherein the head holder comprises a pair of blocks installed on opposing sides thereof, the pair of blocks pressing opposing sides of the outer surface of the screw head enclosed in the head holder inward to restrict rotation of the screw head.

3. The welding jig for pedicle screw according to claim 2, wherein each of the opposing sides of the outer surface of the screw head has a groove into which a respective one of the pair of blocks is inserted.

4. The welding jig for pedicle screw according to claim 1, further comprising a lock nut,
wherein the first mounting part comprises a screw section at one end thereof, and
wherein the lock nut is fastened to the screw section, the lock nut firmly locking the head holder and the screw head to the first mounting part by pushing against the head holder.

5. The welding jig for pedicle screw according to claim 1,
wherein the interior of the jig core has a flow passage formed longitudinally, and
wherein the outer surface of the jig core has a purge hole which is connected to the flow passage such that a gas fed through the flow passage can be sprayed onto the inside of the welding regions of the screw head and the wings.

6. The welding jig for pedicle screw according to claim 1,
wherein each of the pair of wings has a first bridge extended from a region of contact with the screw head,
wherein the screw head has a second bridge coupled to the first bridge, and
wherein the first and second bridges are removed after completion of welding.

7. A welding apparatus for pedicle screw comprising:
a welding jig for pedicle screw comprising a jig core, a head holder, and a pair of wing holders;
a turntable having the jig locked thereto; and
a welding torch for applying power to welding regions of the pair of wings and the screw head locked to the jig core.

8. The welding apparatus for pedicle screw according to claim 7, wherein the turntable has a rotational speed in the range of 0.1-10 rpm.

9. The welding apparatus for pedicle screw according to claim 7, wherein the electric current applied to the welding regions by the welding torch is less than or equal to 100 A, and wherein and the voltage less than or equal to 20 V.

10. A welding method for pedicle screw comprising:
locking a screw head of a pedicle screw to a first mounting part of a jig core;
locking a pair of wings to a second mounting part of the jig core in such a manner that a welding region of the pair of wings comes in contact with a welding region of the screw head;
locking the jig core to the top surface of a turntable;
rotating the turntable; and
applying power to the welding regions of the screw head and the wings by using a welding torch.

11. The welding method for pedicle screw according to claim 10, wherein locking the screw head to the first mounting part comprises:
inserting the first mounting part into the screw head;
covering the screw head using a head holder; and
pressing the head holder by coupling a lock nut to a screw section formed at the end of the first mounting part.

12. The welding method for pedicle screw according to claim 10, wherein locking the pair of wings to the second mounting part comprises:
attaching the pair of wings to an outer surface of the second mounting part; and
covering the pair of wings with a pair of wing holders and thereafter coupling the wing holders to each other.

13. The welding method for pedicle screw according to claim 10, further comprising preheating the welding regions of the screw head and the wings before the turntable starts to rotate.

14. The welding method for pedicle screw according to claim 10, further comprising spraying an inert gas onto the inside of the welding regions of the screw head and the wings during welding of the screw head and the wings.
